(19) United States
(12) Patent Application Publication
(10) Pub. No.: US 2007/0067665 A1
(43) Pub. Date: Mar. 22, 2007

(54) Apparatus and method for providing redundant arrays storage devices

(76) Inventor: Ebrahim Hashemi, Los Gatos, CA (US)

Correspondence Address: Lester H. Birnbaum, 2159 Greenmeadow Drive, Macungie, PA, 18062, US

(21) Appl. No.: 11/229,917

(22) Filed: Sep. 19, 2005

(51) Int. Cl. G06F 11/00

(52) U.S. Cl. 714/6

(57) ABSTRACT

A storage system and method are disclosed for providing redundant arrays of storage devices such as magnetic disks. Each array includes a data portion with available data space and a spare portion. A controller monitors the size of available space as data fills up the array, and reconfigures the array when the available space reaches a predetermined minimum size or when the spare portion is filled. The number of disks is minimized since the spare portions utilize the unfilled portion of the disks that would normally include only data.

### FIELD OF THE INVENTION

The present invention relates generally to data storage systems and, more particularly, to providing redundant arrays of storage devices.

### BACKGROUND OF THE INVENTION

Storage of information is a key part of modern computers. Usually, data is stored on magnetic disks, although other forms of storage, such as magnetic tape and flash memory can be employed. In order to keep pace with the increasing processing speeds of computers, it has been suggested that arrays of disks be employed in a parallel arrangement. Since each disk has its own controller, data transfer is much faster than a single disk. (See, e.g., Patterson, et al, “A case for Redundant Arrays of Inexpensive Disks (RAID)”, Proceedings of the 1988 ACM-SIGMOD Conference on Management of Data, Chicago, Ill., pp 109-116, June 1988.)

The use of an array of inexpensive disks, however, increases the failure rate of the storage system, and therefore, necessitates the use of extra disks with redundant information and spare portions so that, if a disk fails, the information on that disk can be recovered and stored in the spare portions. Such systems have been designated Redundant Arrays of Inexpensive Disks (RAID). In one such system, a separate disk is provided with the redundant information in an arrangement known as RAID 4. (See, e.g., Patterson, cited above, at pages 113-114.) In another system, the redundant information is distributed among the disks, a concept also known as RAID 5. In order to reduce the mean time to repair, a dedicated spare is often added to the array in either system. Spare portions are sometimes distributed among all the disks, a concept known as “distributed sparing”. (See, e.g., Patterson, and U.S. Pat. No. 5,258,984 issued to Menon et al.).

One of the problems with these systems is that the size of the spare portions were fixed, and when the data area was filled up, the system was unable to accept new data until new disks were added to the system, although plenty of space might be available. It is generally desirable to keep the number of disks to a minimum, and provide a system that will automatically reconfigure itself when data portions or spare portions fill up.

### SUMMARY OF THE INVENTION

The invention in accordance with one aspect is a storage system that includes an array of storage devices, each of which includes a data storage portion with available data space and a spare portion. A controller is electrically coupled to the array. The system is configured to monitor the size of space available for data and to convert between spare portions and available data space. In one embodiment, the spare portion is converted to available data space in the event that additional space is needed for the data portion. In another embodiment, the space available for data is converted to a spare portion in the event the initial spare portion has filled up because of a disk failure.

In accordance with another aspect, the invention is a method for providing redundancy in an array of storage devices, the method including providing a spare portion and a data storage portion with available data space on at least one disk, monitoring the amount of space available for data, and converting between a spare portion and available data space. In one embodiment, the spare portion is converted to available data space if additional data storage is needed on the disk. In another embodiment, the available data space is converted to a spare portion in the event the initial spare portion has filled up because of a disk failure.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice in the industry, the various features of the drawing are not to scale. On the contrary, the dimensions of the various features are arbitrarily expanded or reduced for clarity. Included in the drawing are the following figures:

FIG. 1 is a block software diagram of a storage system including features of the invention in accordance with one embodiment;

FIG. 2 is a block hardware diagram of a storage system in accordance with the same embodiment;

FIG. 3 is a flow diagram illustrating the steps performed by the system in accordance with one embodiment of the method aspects of the invention;

FIG. 4 is a schematic illustration of an array of storage devices illustrating recovery of data in accordance with an embodiment of the invention;

FIG. 5 is an example of how a typical disk array may be configured in accordance with an embodiment of the invention;

FIG. 6 is an example of how the same disk array can be reconfigured in accordance with an embodiment of the invention;

FIG. 7 is an example of how a disk array may be configured in accordance with another embodiment of the invention; and

FIG. 8 is an example of how the same disk array may be reconfigured in accordance with the same embodiment,

### DETAILED DESCRIPTION OF THE INVENTION

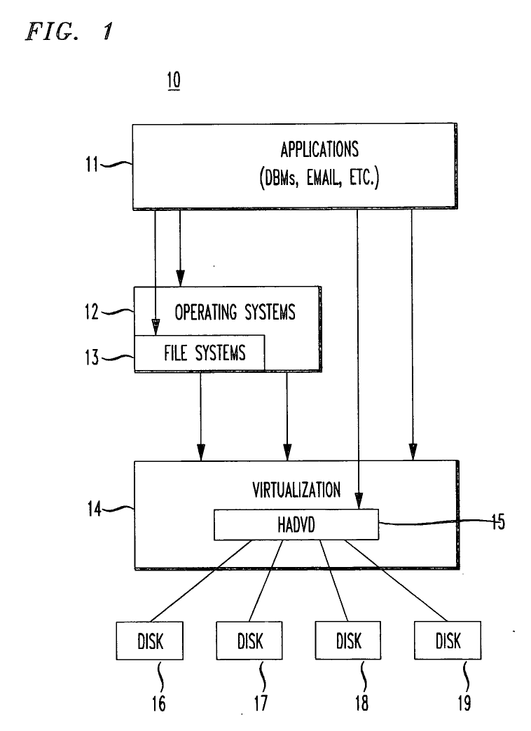

Referring now to the drawing, wherein like reference numerals refer to like elements throughout, FIG. 1 is a block diagram of a basic storage system, 10, that utilizes the invention. In this particular embodiment, the system is a Direct Attached Storage (DAS) system where the storage devices are coupled to a computer. It will be appreciated that the invention is equally applicable to Storage Area Networks (SAN) where storage devices can be accessed by multiple users, and Network Attached Storage (NAS) systems where the storage devices can be accessed by users over the internet or over a Local Area Network (LAN).

The software of the system includes the standard applications programs, 11, such as Data Base Management Systems (DBMS) and E-Mail, one or more operating systems, 12, and file systems, 13. The system further includes a virtualization layer 14, which is coupled to and manages the storage devices, in this example, magnetic disks 16-19. It should be appreciated that each block, 16-19, can be an individual disk or an array of disks. (See, e.g., U.S. Pat. No. 5,258,984 issued to Menon, et al.) It will also be appreciated that the applications, operating systems, and file systems normally have access to the storage devices through the virtualization layer, but can also have direct access to the devices.

In accordance with a feature of the invention, a new layer of software, 15, is added to the virtualization layer and is designated Higher Availability Dynamic Virtual Devices (HADVD). This feature, as discussed in more detail below, provides the capability of utilizing the unused portion of standard data disks, taking advantage of the fact that such disks usually have a great amount of unused space over a significant period of time. This unused space can be used as a spare portion by reconfiguring the disk array in the event a disk fails and fills up the initial spare portion. This reconfiguration, for example, can involve changing the bit map of the array to indicate that what was once available for data is now a spare portion. It can also involve moving the spare portions when a new disk is inserted. In a further embodiment, if the available space for data falls below a minimum threshold, the disk array can be reconfigured to take a portion of the space from the initial spare portion and convert it to available data space, again by changing the bit map. Thus, the invention allows a dynamic change in the size and location of spare portions needed for redundancy without the requirement of any additional disks. Further, when the spare portion is reconfigured, it is not necessary to shut down the system. Rather, it is desirable to merely provide a warning that the amount of spare space has been diminished so that the user can add another disk if needed.

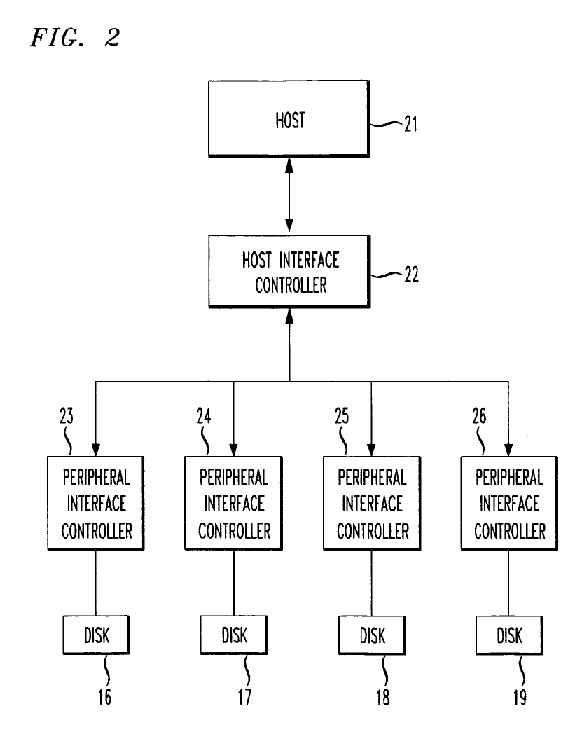

FIG. 2 is a block diagram of the basic hardware of the storage system in accordance with the same embodiment. A host processor, 21, is connected to a host interface controller, 22, which is, in turn, connected to an array of peripheral interface controllers, 23-26. Each peripheral interface controller, 23-26, is connected to its own disk, 16-19, respectively, for example in a DAS environment. In a SAN environment, each peripheral controller, 23-26, could be a storage area network switch, in which case each block, 16-19, could be an array of disks.

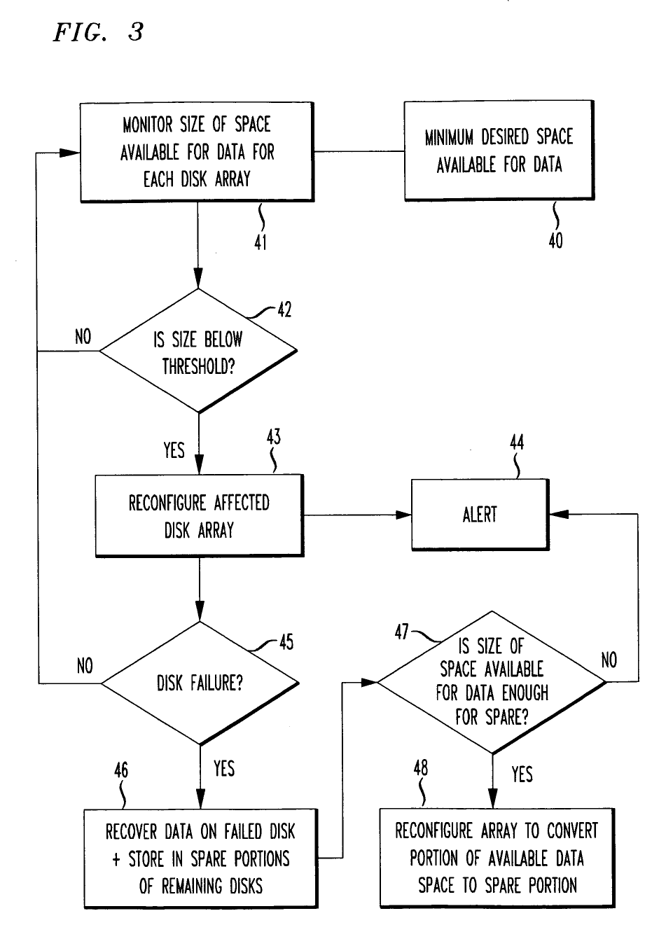

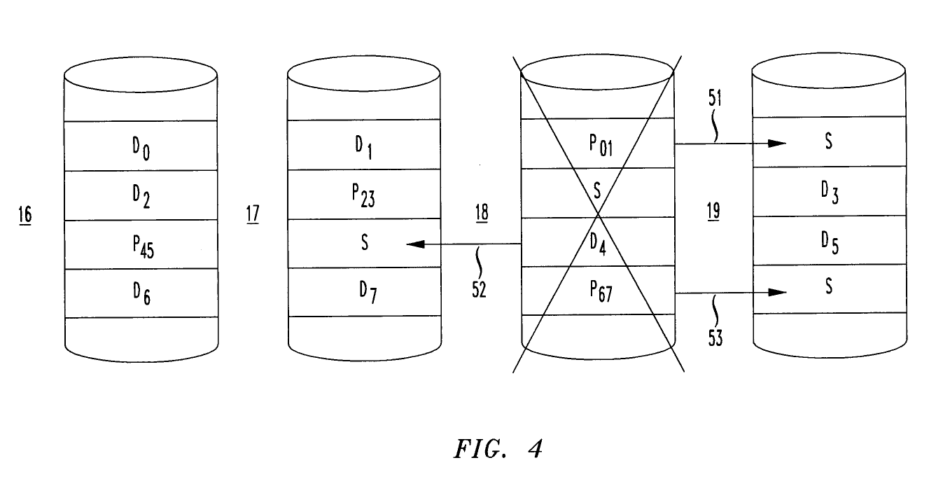

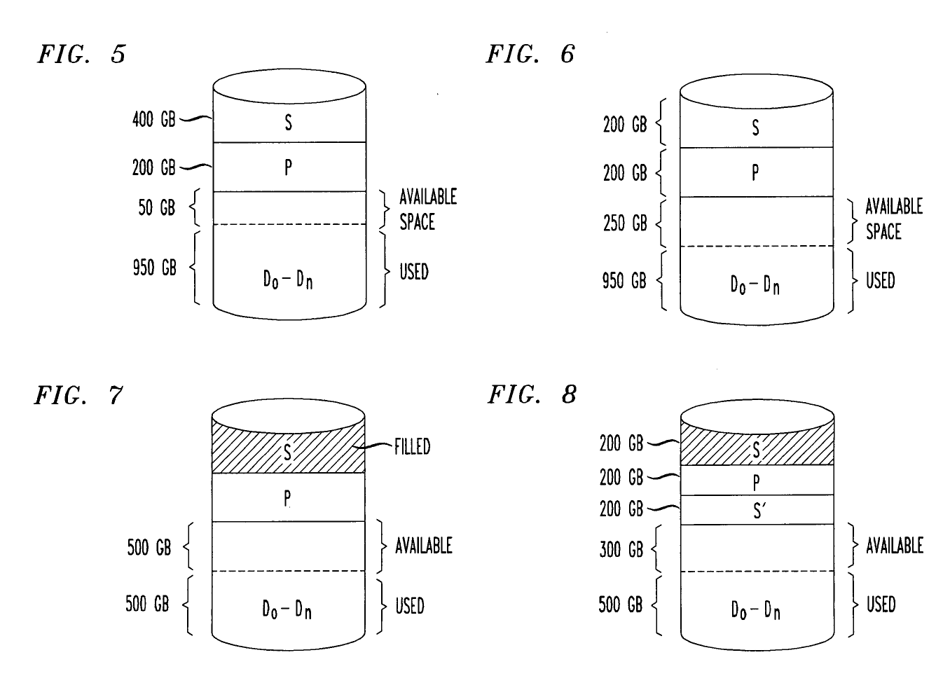

FIG. 3 is a flow diagram illustrating some of the steps performed by the HADVD control layer, 15 of FIG. 1. The software can reside in any of the elements illustrated in FIG. 2, but usually resides either in the host interface controller, 22, or in the peripheral controllers, 23-26. It is assumed that all the disks (16-19) include a data portion, a spare portion, and a parity portion as shown and described in more detail below in relation to FIGS. 4-8. A minimum desired size of the unused space available for data (threshold) is stored and is available to the control layer as indicated by block 40. The control layer continually monitors the size of the space available for data for the disk array as illustrated by block 41. A decision is made as to whether the size of the available space has reached the threshold value as a result of data added to the disk array. This step is illustrated by block 42. If the threshold has been reached, the control layer reconfigures the disk array so that the available data space can accept additional data as shown by block 43 and described in more detail below with regard to FIGS. 5 and 6. The disk array is therefore able to continue to store additional data and provide needed redundancy information. The sizes of the spare portions of the disks are therefore dynamically controlled to suit the changing needs of the recording system. Once the disk array has been reconfigured, the system can alert the users that the full spare portion is no longer available on that disk, as illustrated by block 44.

As further illustrated in the diagram of FIG. 3, the control layer, 15, also monitors the disk array to determine if one or more of the disks has failed or is about to fail. This step is illustrated by block 45. If such a failure has occurred, the control layer can recover the data on the failed disk and store it in spare portions of the remaining disks as illustrated by block 46. The control layer can then determine if there is sufficient space available in the data portions to create new spare portions as illustrated by block 47. If not, the system can alert the user that there is no more room for spare portions if another disk fails. The system will continue to operate, however. If there is sufficient space, the disks can be reconfigured, as illustrated by block 48, to convert a portion of the available data space to new spare portions to be used in case of an additional disk failure. This feature is described in more detail below in regard to FIGS. 7 and 8.

FIG. 4 is a schematic illustration of the recovery of data from a failed disk in accordance with an embodiment of the invention. FIG. 4 schematically illustrates four stripes of an array of four disks, 16-19. Stripes including data (data portions) are indicated by “D” with a subscript, stripes including parity bits are indicated by “P” with a subscript, and empty stripes are indicated by “S”. Each disk will also include an unused portion available for data which is not shown in this figure.

In this example, it is assumed that disk 18 has failed. In response thereto, the controller reconfigures the array by recovering the lost data D₄. This is accomplished by XORing the parity and data bits on the same stripe of the remaining disks (i.e., P₄₅ and D₅). The control layer then moves the recovered data to an empty portion on another disk, in this example disk 17, as indicated by arrow 52. The control layer also recovers the lost parity bits (P₀₁ and P₆₇) by adding data bits from the same stripe of other disks (i.e., D₀+D₁ and D₆+D₇, respectively.) The recovered parity bits are moved to empty portions (S) of other disks, in this example, disk 19, as indicated by arrows, 51 and 53.

It will be appreciated that additional disks are not needed for spare redundancy since the control layer will monitor the disk array as it fills up with data, and if the data portions of the disk array get too full, will alert the user that data space is running low (block 44 of FIG. 3). At that point, a user could insert an additional disk, but the system need not shut down. In the case of multiple arrays of disks, the recovered data from a failed disk in one array could be moved to spare portions of disks in another array.

FIG. 5 illustrates a disk array in the form of a logical single disk in accordance with an embodiment of the invention. In this example, the spare portion, S, is about 400 GB (GigaBytes), the parity portion, P, is 200 GB, and the data portion is 1,000 GB. (It will be appreciated that these portions will be divided among the various disks in the array in accordance with particular needs.) Initially, the data portion is empty, and then starts to fill up with data in the form of data blocks, D₀−Dₙ where n is chosen according to particular needs. At the point shown in FIG. 5, the data portion has used 950 GB of the original available data space, leaving only 50 GB of available space. Assuming that 50 GB is the threshold value (block 40 of FIG. 4), the control layer will reconfigure the disk array (block 43) as illustrated in FIG. 6. It will be noted that the spare portion, S, has been reduced to 200 GB and the space available for data has been increased to 250 GB. This reconfiguration allows the system to continue to operate until a new disk is inserted.

FIG. 7 illustrates a disk array in the form of a logical single disk in accordance with another embodiment of the invention. Here, the spare portion, S, has been filled as a result of a failed disk. The data has filled only 500 GB, leaving 500 GB of available data space. The control layer then reconfigures the disk array as shown in FIG. 8. A new spare portion, S′, of 200 GB has been created from the available data space, leaving 300 GB of available data space. The disk array can therefore receive reconstructed data in the event of another disk failure, and still continue receiving new data in the available space.

Although the invention has been described with reference to exemplary embodiments, it is not limited to those embodiments. For example, although magnetic recording disks were described, the invention would also be applicable to other recording devices such as optical disks, magnetic tape, and flash memory chips. Rather, the appended claims should be construed to include other variants and embodiments of the invention which may be made by those skilled in the art without departing from the true spirit and scope of the present invention.

What is claimed:

1. A storage system comprising:
an array of storage devices, the array including a data storage portion with an available data space and an initial spare portion; and
a controller electrically coupled to the array, the controller configured to monitor the size of the available data space and to convert space on the array between a spare portion and available data space.

2. The system according to claim 1 wherein the controller is configured to convert a portion of the initial spare portion into an available data space in the event that the available data space reaches a threshold minimum value.

3. The system according to claim 1 wherein the controller is configured to convert a portion of the available data space into a new spare portion in the event that the initial spare portion is filled.

4. The system according to claim 1 wherein the storage devices are magnetic recording disks.

5. The system according to claim 1 wherein the controller is further configured to alert a user in the event that the size of available data space reaches a threshold minimum value.

6. The system according to claim 1 including multiple arrays of storage devices having data and spare portions that are monitored by the controller.

7. A method for providing redundancy in an array of storage devices, the method including providing an initial spare portion and a data storage portion with an available data space on the array, monitoring the size of the available data space, and converting space on the array between a spare portion and available data space.

8. The method according to claim 7 wherein the initial spare portion is converted to available data space in the event that the available data space reaches a threshold minimum value.

9. The method according to claim 7 wherein a portion of the available data space is converted to a new spare portion in the event that the initial spare portion is filled.

10. The method according to claim 7 further comprising alerting a user in the event the size of the available data space reaches a threshold minimum value.

11. The method according to claim 7 further comprising recovering data in the event the device fails and storing the data on another device in the array.

12. The method according to claim 11 wherein the recovered data is stored on another device in another array.
